(19) United States
(12) Patent Application Publication
(10) Pub. No.: US 2026/0052374 A1
(43) Pub. Date: Feb. 19, 2026

(54) COMMUNICATION CONTROL METHOD, COMMUNICATION DEVICE, AND STORAGE MEDIUM

(71) Applicant: BEIJING XIAOMI MOBILE SOFTWARE CO., LTD., Beijing (CN)

(72) Inventor: Yuxin MAO, Beijing (CN)

(73) Assignee: BEIJING XIAOMI MOBILE SOFTWARE CO., LTD., Beijing (CN)

(21) Appl. No.: 19/101,640

(22) PCT Filed: Aug. 10, 2022
(86) PCT No.: PCT/CN2022/111544

§ 371 Date: Feb. 6, 2025

(51) Int. Cl. H04W 8/22; H04W 60/06; H04W 76/30

(52) U.S. Cl. CPC H04W 8/22; H04W 60/06; H04W 76/30

(57) ABSTRACT

A communication control method is performed by a first core network device. The method includes determining whether to perform caching and forwarding functions on transmission data of a user equipment (UE) based on communication status information in response to a feeder link being about to be interrupted. The communication status information includes at least one of: caching and forwarding support capability information of an access network device, caching and forwarding support capability information of a core network device, or user subscription information.

### CROSS-REFERENCE TO RELATED APPLICATION

This application is a national phase entry under 35 USC § 371 of International Application PCT/CN2022/111544, filed Aug. 10, 2022, the entire disclosure of which is incorporated herein by reference.

### FIELD

The present disclosure relates to, but is not limited to, the technical field of communication technologies, and more particularly to a communication control method, system and apparatus, a communication device, and a storage medium.

### BACKGROUND

When a user equipment (UE) is connected to a core network (CN) device via an access network (AN) device such as a next-generation node B (gNB), for example, the access network is an access network formed by a satellite and a ground receiving station, due to factors such as limited satellite coverage, a feeder link between the satellite and the ground station used to connect a core network device will be disconnected.

In the related technology, it is impossible to flexibly respond to the disconnection of the feeder link, which causes a UE service to be unable to continue normally during the process of the disconnection of the feeder link.

### SUMMARY

Embodiments of the present disclosure provide a communication control method, system and apparatus, a communication device, and a storage medium.

In a first aspect, an embodiment of the present disclosure provides a communication control method, which is performed by a first core network device. The method includes: determining whether to perform caching and forwarding functions on transmission data of a user equipment (UE) based on communication status information in response to a feeder link being about to be interrupted, where the communication status information includes at least one of: caching and forwarding support capability information of an access network device, caching and forwarding support capability information of a core network device, or user subscription information.

In a second aspect, an embodiment of the present disclosure provides a communication control method, which is performed by an access network device. The method includes: determining whether to perform caching and forwarding functions on transmission data of a UE according to a notification transmitted by a first core network device based on communication status information in response to a feeder link being about to be interrupted, where the communication status information includes at least one of: caching and forwarding support capability information of the access network device, caching and forwarding support capability information of a core network device, or user subscription information.

In a third aspect, an embodiment of the present disclosure provides a communication control method, which is performed by a second core network device. The method includes: determining whether to perform caching and forwarding functions on transmission data of a UE according to a notification transmitted by a first core network device based on communication status information in response to a feeder link being about to be interrupted, where the communication status information includes at least one of: caching and forwarding support capability information of an access network device, caching and forwarding support capability information of a core network device, or user subscription information.

In a fourth aspect, an embodiment of the present disclosure provides a communication control system. The system includes: a first core network device, an access network device, and a second core network device.

The first core network device is configured to receive an N2 connection release request transmitted by the access network device, and determine whether to perform caching and forwarding functions on transmission data of a UE based on communication status information in response to a feeder link being about to be interrupted; where the communication status information includes at least one of: caching and forwarding support capability information of the access network device, caching and forwarding support capability information of a core network device, or user subscription information.

The access network device is configured to transmit the N2 connection release request to the first core network device, in response to detecting that the feeder link is about to be interrupted, and determine whether to perform the caching and forwarding functions on the transmission data of the UE based on a notification transmitted by the first core network device based on the communication status information.

The second core network device is configured to determine whether to perform the caching and forwarding functions on the transmission data of the UE according to the notification transmitted by the first core network device based on the communication status information.

In a fifth aspect, an embodiment of the present disclosure provides a communication control apparatus, applied to a first core network device. The apparatus includes: a first performing unit, configured to: determine whether to perform caching and forwarding functions on transmission data of a user equipment (UE) based on communication status information in response to a feeder link being about to be interrupted, where the communication status information includes at least one of: caching and forwarding support capability information of an access network device, caching and forwarding support capability information of a core network device, or user subscription information.

In a sixth aspect, an embodiment of the present disclosure provides a communication control apparatus, applied to an access network device. The apparatus includes: a second performing unit, configured to: determine whether to perform caching and forwarding functions on transmission data of a UE according to a notification transmitted by a first core network device based on communication status information in response to a feeder link being about to be interrupted, where the communication status information includes at least one of: caching and forwarding support capability information of the access network device, caching and forwarding support capability information of a core network device, or user subscription information.

In a seventh aspect, an embodiment of the present disclosure provides a communication control apparatus, applied to a second core network device. The apparatus includes: a third performing unit, configured to: determine whether to perform caching and forwarding functions on transmission data of a UE according to a notification transmitted by a first core network device based on communication status information in response to a feeder link being about to be interrupted, where the communication status information includes at least one of: caching and forwarding support capability information of an access network device, caching and forwarding support capability information of a core network device, or user subscription information.

In an eighth aspect, an embodiment of the present disclosure provides a communication device, which includes: a processor, a processor, and an executable program stored in the memory and executable by the processor. The processor is configured to execute the executable program to perform the communication control method in the first aspect, the second aspect or the third aspect described above.

In a ninth aspect, an embodiment of the present disclosure provides a non-transitory computer-readable storage medium, which stores an executable program. The executable program, when executed by a processor, causes the communication control method in the first aspect, the second aspect or the third aspect described above to be implemented.

It is to be understood that both the foregoing general description and the following detailed description are illustrative and explanatory only, and are not intended to limit the embodiments of the present disclosure.

### BRIEF DESCRIPTION OF THE DRAWINGS

The accompanying drawings, which are incorporated in and constitute a part of this specification, illustrate embodiments of the invention and are used to explain principles of the embodiments of the invention in combination with the description.

FIG. 1 is a schematic structural diagram of a wireless communication system according to an illustrative embodiment.

FIG. 2 is a schematic flowchart of a communication control method according to an illustrative embodiment.

FIG. 3 is a schematic structural diagram of a communication control system according to an illustrative embodiment.

FIG. 4 is a schematic flowchart of a communication control method according to an illustrative embodiment.

FIG. 5 is a schematic flowchart of a communication control method according to an illustrative embodiment.

FIG. 6 is a schematic flowchart of a communication control method according to an illustrative embodiment.

FIG. 7 is a schematic flowchart of a communication control method according to an illustrative embodiment.

FIG. 8 is a schematic flowchart of a communication control method according to an illustrative embodiment.

FIG. 9 is a schematic flowchart of a communication control method according to an illustrative embodiment.

FIG. 10 is a schematic flowchart of a communication control method according to an illustrative embodiment.

FIG. 11 is a schematic flowchart of a communication control method according to an illustrative embodiment.

FIG. 12 is a schematic flowchart of a communication control method according to an illustrative embodiment.

FIG. 13 is a schematic structural diagram of a communication control apparatus according to an illustrative embodiment.

FIG. 14 is a schematic structural diagram of a communication control apparatus according to an illustrative embodiment.

FIG. 15 is a schematic structural diagram of a communication control apparatus according to an illustrative embodiment.

FIG. 16 is a schematic structural diagram of a UE according to an illustrative embodiment.

FIG. 17 is a schematic structural diagram of a communication device according to an illustrative embodiment.

### DETAILED DESCRIPTION

Illustrative embodiments will be described in detail herein, examples of which are illustrated in the accompanying drawings. The following description refers to the accompanying drawings in which the same numbers in different drawings refer to the same or similar elements unless otherwise indicated. The implementations set forth in the following description of illustrative embodiments do not represent all implementations consistent with the embodiments of the present invention. They are merely examples of apparatuses and methods consistent with some aspects of the embodiments of the present invention as recited in the appended claims.

Terms used in the embodiments of the present disclosure are only for the purpose of describing specific embodiments, and shall not be construed to limit the present disclosure. As used in the embodiments of the present disclosure and the appended claims, “a/an” and “the” in a singular form are intended to include plural forms, unless clearly indicated in the context otherwise. It should be understood that, the term “and/or” used herein represents and contains any one of associated listed items and all possible combinations of more than one associated listed items.

It should be understood that terms such as “first”, “second” and “third” may be used in the embodiments of the present disclosure for describing various information, these information should not be limited by these terms. These terms are only used for distinguishing information of the same type from others. For example, first information may also be referred to as second information, and similarly, the second information may also be referred to as the first information, without departing from the scope of the embodiments of the present disclosure. As used herein, the term “if” may be construed to mean “when” or “upon” or “in response to determining” depending on the context.

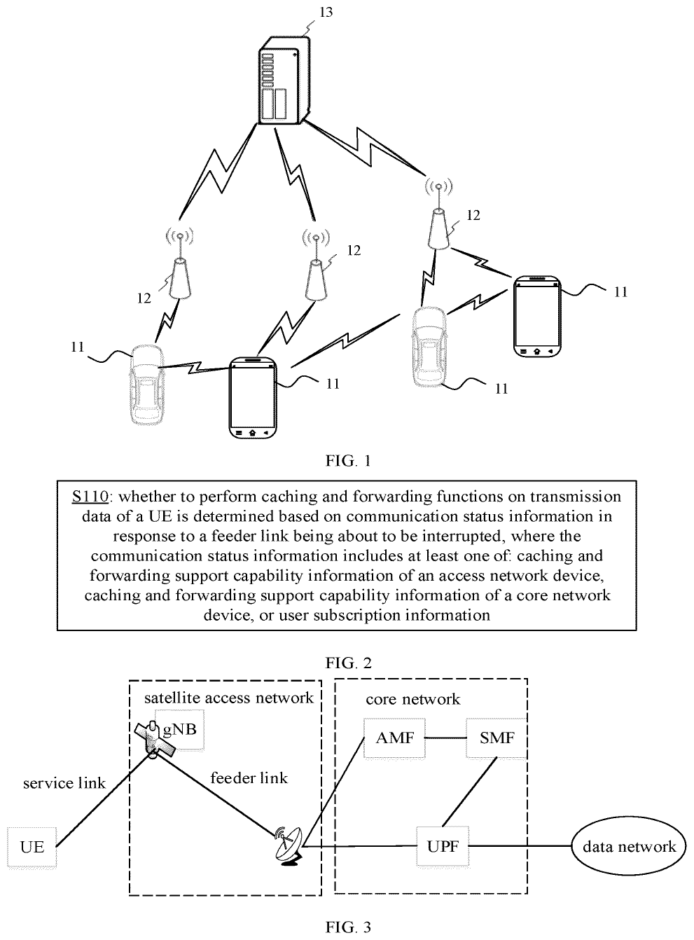

Reference is made to FIG. 1, which is a schematic structural diagram of a wireless communication system provided by an embodiment of the present disclosure. As shown in FIG. 1, the wireless communication system is a communication system based on the cellular mobile communication technology, and the wireless communication system may include several UEs 11 and several access devices 12.

A UE 11 may be a device that provides voice and/or data connectivity to a user. The UE 11 may communicate with one or more core networks via a radio access network (RAN), and the UE 11 may be a terminal device in an Internet of Things (IOT), such as a sensor device, a mobile phone (or referred to as a “cellular” phone) and a computer including an IoT terminal device. For example, the UE 11 may be a fixed device, a portable device, a pocket device, a hand-held device, a computer built-in device or a vehicle-mounted device. For example, the UE 11 may be a station (STA), a subscriber unit, a subscriber station, a mobile station, a mobile, a remote station, an access point, a remote terminal, an access terminal, a user terminal, a user agent, a user device, or a user equipment. Alternatively, the UE 11 may also be a device of an unmanned aerial vehicle. Alternatively, the UE 11 may also be a vehicle-mounted device, for example, it may be a trip computer with a wireless communication function, or a wireless communication device connected externally to the trip computer. Alternatively, the UE 11 may also be a roadside device, for example, it may be a street lamp, a signal lamp, or other roadside devices with a wireless communication function.

The access device 12 may be a network-side device in the wireless communication system. The wireless communication system may be the 4th generation (4G) mobile communication system, also referred to as a long term evolution (LTE) system, or the wireless communication system may be a 5G system, also referred to as a new radio (NR) system or 5G NR system. Alternatively, the wireless communication system may be a next-generation system of the 5G system. An access network in the 5G system is referred to as new generation-radio access network (NG-RAN).

The access device 12 may be an evolved node B (eNB) in a 4G system. Alternatively, the access device 12 may be a next-generation node B (gNB) adopting a centralized and distributed architecture in the 5G system. When the access device 12 adopts the centralized and distributed architecture, it generally includes a central unit (CU) and at least two distributed units (DU). The centralized unit is provided with a protocol stack of a packet data convergence protocol (PDCP) layer, a radio link control (RLC) layer, a media access control (MAC) layer. The distributed unit is provided with a physical (PHY) layer protocol stack. The specific implementation of the access device 12 is not limited in the embodiments of the present disclosure.

A wireless connection may be established between the access device 12 and the UE 11 through a wireless radio interface. In different embodiments, the wireless radio interface is a wireless radio interface based on the fourth generation (4G) mobile communication network technology standard; or the wireless radio interface is a wireless radio interface based on the fifth generation (5G) mobile communication network technology standard, such as a new radio interface; or the wireless radio interface is a wireless radio interface based on a next-generation (from 5G) mobile communication network technology standard.

Optionally, the above wireless communication system may further include a network management device 13. Several access devices 12 are connected to the network management device 13. The network management device 13 may be a core network device in the wireless communication system, for example, the network management device 13 may be a mobility management entity (MME) in an evolved packet core (EPC) network. Alternatively, the network management device may be other core network devices, such as a serving gateway (SGW), a public data network gateway (PGW), a policy and charging rule function (PCRF) unit or a home subscriber server (HSS), etc. The implementation form of the network management device 13 is not limited in the embodiments of the present disclosure.

As shown in FIG. 2, an embodiment of the present disclosure provides a communication control method, which is performed by a first core network device. The method includes the following steps.

In step S110, whether to perform caching and forwarding functions on transmission data of a UE is determined based on communication status information in response to a feeder link being about to be interrupted, where the communication status information includes at least one of: caching and forwarding support capability information of an access network device, caching and forwarding support capability information of a core network device, or user subscription information.

In the embodiments of the present disclosure, as shown in FIG. 3, the access network may include multiple access devices, such as a satellite equipped with gNodeB (gNB) and a ground receiving station. The core network may communicate with the ground receiving station and is configured to establish a connection with the satellite through the ground receiving station. The core network may include multiple core network devices, such as access and mobility management function (AMF), user plane function (UPF), and session management function (SMF). The first core network device may be an AMF. The feeder link may be a connection link between the satellite equipped with gNB and the ground receiving station, and a service link may be a connection link between the satellite equipped with gNB and a UE.

In an embodiment, step S110 may include: in response to the feeder link being about to be interrupted, determining whether to perform the caching and forwarding functions on the transmission data of the UE based on the communication status information, and transmitting a notification. The transmitting the notification may include transmitting the notification to the access network device and/or a second core network device.

For example, the transmitting the notification to the access network device and/or the second core network device may include: notifying the access network device and/or the second core network device to perform the caching and forwarding functions on the transmission data of the UE.

In an embodiment, the communication status information may indicate an operating status of a current network, capability information of the network device, etc. For example, the caching and forwarding support capability information of the access network device may indicate whether the gNB supports the caching and forwarding functions on the transmission data. The caching and forwarding support capability information of the core network device may indicate whether the core network device such as AMF, SMF or UPF supports the caching and forwarding functions on the transmission data. The user subscription information may indicate a service type corresponding to a currently subscribed UE, etc. For example, the user subscription information may include a type identifier of a service subscribed by the UE.

In an embodiment, in response to the feeder link being about to be interrupted may be in response to the access network device detecting that the feeder link is about to be interrupted. The access network device may be a base station gNB or the like. For example, the feeder link being about to be interrupted may be determined based on feeder link information. For example, the feeder link being about to be interrupted may be determined based on an establishment time instant and/or an establishment duration of the feeder link.

In an embodiment, the feeder link being about to be interrupted may be determined based on feeder link information, or may be determined based on a historical interruption situation of the feeder link. For example, the feeder link being about to be interrupted is determined based on the historical interruption situation of the feeder link, the establishment time instant and/or the establishment duration of the feeder link.

In an embodiment, the caching and forwarding the transmission data of the UE may include caching and forwarding uplink data of the UE, and/or caching and forwarding downlink data of the UE. The caching and forwarding functions on the uplink data of the UE may be performed by the access network device, and the caching and forwarding functions on the downlink data of the UE may be performed by the core network device such as at least one of AMF, UPF or SMF.

In an embodiment, the caching and forwarding the transmission data of the UE may include caching the uplink data transmitted by the UE and/or caching the downlink data transmitted to the UE when the feeder link is interrupted, and forwarding the cached uplink data and/or forwarding the cached downlink data when a connection of the feeder link is resumed.

In an embodiment, the determining whether to perform the caching and forwarding functions on the transmission data of the UE based on the communication status information may include: determining whether to perform the caching and forwarding functions on the transmission data of the UE based on the caching and forwarding support capability information of the access network device, and/or the caching and forwarding support capability information of the core network device.

In an embodiment, in a case that the caching and forwarding support capability information of the access network device indicates that the access network device supports the caching and forwarding functions on the transmission data of the UE, and the caching and forwarding support capability information of the core network device indicates that the core network device supports the caching and forwarding functions on the transmission data of the UE, it is determined that the caching and forwarding functions on the transmission data of the UE are performed.

In an embodiment, in a case that the caching and forwarding support capability information of the access network device indicates that the access network device cannot support the caching and forwarding functions on the transmission data of the UE, and/or the caching and forwarding support capability information of the core network device indicates that the core network device cannot support the caching and forwarding functions on the transmission data of the UE, it is determined that the caching and forwarding functions on the transmission data of the UE are not performed.

In an embodiment, in a case that the caching and forwarding support capability information of the access network device indicates that the access network device supports the caching and forwarding functions on the transmission data of the UE, and the caching and forwarding support capability information of the core network device indicates that the core network device supports the caching and forwarding functions on the transmission data of the UE, the communication status information may further include: timer information, used to indicate a timing duration for performing the caching and forwarding functions on the transmission data of the UE.

In an embodiment, the determining whether to perform the caching and forwarding functions on the transmission data of the UE based on the communication status information further includes: determining whether to perform the caching and forwarding functions on the transmission data of the UE based on the user subscription information. For example, in a case that the user subscription information indicates that a type of a service subscribed by the UE is a preset type, it is determined to perform the caching and forwarding functions on the transmission data of the UE.

For example, in a case that the user subscription information indicates that the type of the service subscribed by the UE is a type of a high-latency service, it is determined to perform the caching and forwarding functions on the transmission data of the UE.

For example, when the user subscription information indicates that the type of the service subscribed by the UE is a type of a high-latency service, the caching and forwarding support capability information of the access network device indicates that the access network device supports the caching and forwarding functions on the transmission data of the UE, and the caching and forwarding support capability information of the core network device indicates that the core network device supports the caching and forwarding functions on the transmission data of the UE, it is determined to perform the caching and forwarding functions on the transmission data of the UE.

In an embodiment, the performing the caching and forwarding functions on the transmission data of the UE may include: maintaining a radio resource control (RRC) connection between the access network device and the UE, and starting caching the transmission data of the UE, in response to detecting that the feeder link is interrupted.

In an embodiment, the not performing the caching and forwarding functions on the transmission data of the UE may include: performing de-registration for a UE associated with a first core network device, and interrupting an RRC connection between the UE and the access network device.

In this way, in a case that the feeder link is interrupted, whether to cache and forward the transmission data of the UE can be flexibly determined, which can improve the continuity and the availability of a UE service by data caching and forwarding when needed in the case that the feeder link is interrupted, and whether to perform caching and forwarding can be flexibly adjusted based on the communication status information, which reduces the waste of service resources caused by that the caching and forwarding functions are not supported by a device capability, thereby improving flexibility and efficiency of service processing.

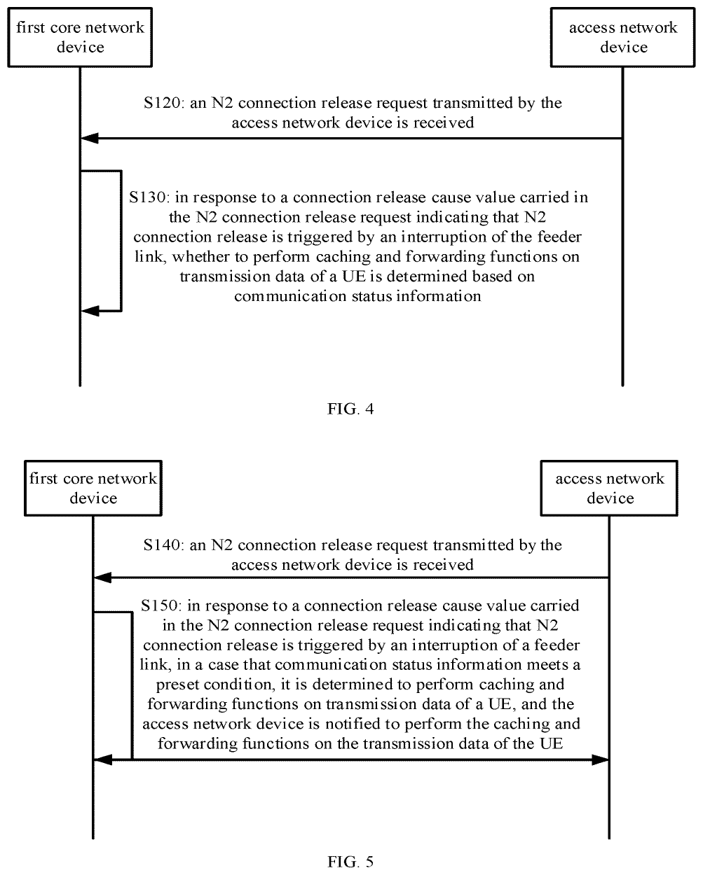

As shown in FIG. 4, an embodiment of the present disclosure provides a communication control method, which is performed by a first core network device. The method may include the following steps.

In step S120, an N2 connection release request transmitted by an access network device is received.

In step S130, in response to a connection release cause value carried in the N2 connection release request indicating that N2 connection release is triggered by an interruption of the feeder link, whether to perform caching and forwarding functions on transmission data of a UE is determined based on communication status information.

In an embodiment of the present disclosure, the N2 connection is a connection link between the base station gNB and the first core network device AMF. The N2 connection release request generated and transmitted by the access network may be an N2 connection release request transmitted by the access network in response to detecting that the feeder link is about to be interrupted.

In an embodiment, the N2 connection release request may request to release UE context recorded by the access network device. The N2 connection release request may carry a cause value, where the cause value indicates a cause for requesting N2 connection release. When the cause value indicates that the N2 connection release is triggered by the interruption of the feeder link, the first core network device may determine that the feeder link is about to be interrupted.

In an embodiment, the method may further include: indicating to release the UE context recorded by the access network device based on the N2 connection release request. For example, when the cause value indicates that the cause for the N2 connection release is the interruption of the feeder link, the first core network device may reduce resources occupied by the context content of the UE disconnected from the access network device by instructing the access network device to release the UE context.

In some embodiments, the N2 connection release request indicates at least one of: a connection release cause value, the caching and forwarding support capability information of the access network device, timer information, or feeder link information. The caching and forwarding support capability information of the access network device indicates whether the access network device supports the caching and forwarding functions, the feeder link information is used to determine at least one of: an establishment time instant, an establishment duration, an interruption time instant, or an interruption duration of the feeder link, and a timer duration corresponding to the timer information is greater than or equal to the interruption duration of the feeder link.

In the embodiments of the present disclosure, the connection release cause value may be a cause identifier that has a mapping relationship with the connection release cause. For example, the connection release cause value may include one or more bit values, and different cause values correspond to different causes for connection release.

In an embodiment, the interruption time instant and the interruption duration of the feeder link may be determined based on the interruption time instant and/or the interruption duration of the feeder link. For example, the interruption time instant and the interruption duration may be determined based on the establishment time instant and the establishment duration of the feeder link, and a historical interruption situation of the feeder link.

In an embodiment, the timer duration is greater than or equal to the interruption duration, which can avoid inability to accurately perform communication control based on a connection resumption of the feeder link due to the shorter timer duration.

As shown in FIG. 5, an embodiment of the present disclosure provides a communication control method, which is performed by a first core network device. The method may include the following steps.

In step S140, an N2 connection release request transmitted by an access network device is received.

In step S150, in response to a connection release cause value carried in the N2 connection release request indicating that N2 connection release is triggered by an interruption of a feeder link, in a case that communication status information meets a preset condition, it is determined to perform caching and forwarding functions on transmission data of a UE, and the access network device is notified to perform the caching and forwarding functions on the transmission data of the UE.

In the embodiments of the present disclosure, the case that the communication status information meets the preset condition may include that the caching and forwarding support capability information of the access network device indicates that the access network device supports the caching and forwarding functions on the transmission data of the UE, and the caching and forwarding support capability information of the core network device indicates that the core network device supports the caching and forwarding functions on the transmission data of the UE.

In an embodiment, the case that the communication status information meets the preset condition may also include that the user subscription information indicates that a type of a service subscribed by the UE is a preset type. For example, the user subscription information indicates that the type of the service subscribed by the UE is a high-latency type, etc.

In an embodiment, the case that the communication status information meets the preset condition may include that a timer duration corresponding to the timer information is less than a preset threshold, and/or an interruption duration of the feeder link is less than the preset threshold, etc. In this way, the interruption duration of the feeder link is less than the preset threshold, which can reduce the amount of data cached during the interruption, thereby reducing resource occupation and waste caused by unnecessary data caching.

In an embodiment, the case that the communication status information meets the preset condition may include at least one of the three aforementioned embodiments, or may also include another type of communication status information meeting the preset condition, which is not specifically limited here.

In an embodiment, the determining to perform the caching and forwarding functions on the transmission data of the UE may include: determining to perform the caching and forwarding functions on downlink data of the UE. For example, it may include: the first core network device performing the caching and forwarding functions on the downlink data of the UE, and/or notifying a second core network device to perform caching and forwarding functions on the downlink data of the UE, etc. The notifying the access network device to perform the caching and forwarding functions on the transmission data of the UE may include: notifying the access network device to perform the caching and forwarding functions on the uplink data of the UE.

The downlink data may be data to be transmitted to the UE by the core network device such as AMF, UPF or SMF, where the data is, for example, service data transmitted by a service server or signaling initiated by the network side. The uplink data may be data to be reported to the access network device such as a base station, where the data is, for example, signaling or service data.

In an embodiment, in response to the connection release cause value carried in the N2 connection release request indicating that N2 connection release is triggered by an interruption of the feeder link, in a case that the communication status information meets a preset condition, the first core network device may also transmit an N2 connection release message to the access network device to instruct the access network device to perform an N2 connection release operation. After receiving the N2 connection release message, the access network device may perform a UE context release operation to release an N2 connection.

In an embodiment, the first core network device may also receive an N2 connection release completion message transmitted by the access network device after completing the N2 connection release.

In some embodiments, the determining to perform the caching and forwarding functions on the transmission data of the UE includes: caching the downlink data of the UE and starting a timing function based on the timer information or the interruption duration of the feeder link; and transmitting the downlink data of the UE cached, in response to resuming a connection between the access network device and the core network device after the timer duration corresponding to the timer information or the interruption duration expires.

In an embodiment, in response to detecting that the feeder link is disconnected, caching of the downlink data of the UE may be started, and the timing function based on the timer information or the interruption duration of the feeder link may be started. The first core network device AMF may be configured to cache the downlink data of the UE, or may be configured to cache the downlink data of the UE together with another core network device such as UPF and/or SMF.

In an embodiment, in a case that the connection between the access network device and the core network device is resumed after the timer duration corresponding to the timer information or the interruption duration expires from a cache starting time of the downlink data, the downlink data cached from the cache starting time is transmitted.

In an embodiment, the resuming the connection between the access network device and the core network device may include resuming a connection of the feeder link, or may include resuming a connection of the feeder link and resuming an N2 connection and an N3 connection. The N2 connection is a connection link between the base station and the AMF, and the N3 connection is a connection link between the base station and the UPF.

In an embodiment, in a case that the feeder link is interrupted and the communication status information meets the preset condition, it is determined to perform the caching and forwarding functions on the transmission data of the UE, and at this time, the N2 connection and the N3 connection are disconnected. When the connection of the feeder link is resumed, the base station may indicate to resume the N2 connection and the N3 connection. In response to all the feeder link, the N2 connection and the N3 connection being resumed, normal communication and interaction can be resumed. In this case, transmission data cached during connection interruption is transmitted, which can ensure the sustainability of a UE service in a discontinuous connection state of the feeder link.

In some embodiments, the method further includes: deleting the downlink data of the UE cached, in response to not resuming the connection between the access network device and the core network device after the timer duration corresponding to the timer information or the interruption duration expires.

In the embodiments of the present disclosure, from the starting time of caching the transmission data of the UE, after the timer duration or the interruption duration has expired, if the connection between the access network device and the core network device is not resumed, such as the feeder link has not been resumed, or the N2 connection and/or the N3 connection has not been resumed after the feeder link is resumed, it may be considered that too much transmission data is cached. Therefore, deleting the cached downlink data of the UE can reduce the occupation by the data cache.

In an embodiment, the method may further include: instructing the access network device to delete the cached UE uplink data, in response to not resuming the connection between the access network device and the core network device after the timer duration corresponding to the timer information or the interruption duration expires. For example, after the timing based on the timer duration or the interruption duration is completed, if the connection between the access network device and the core network device has not been resumed, for example, the connection of the feeder link has not resumed, or the N2 connection and/or the N3 connection has still not been resumed after the feeder link has been resumed, a cache deletion command may be transmitted to the access network device, to instruct the access network device to delete the cached uplink data of the UE.

In this way, if the link has not resumed to a connected state after the timing function has been performed for a certain period of time, it may be considered that the link interruption duration and the data caching time duration are too long, and the cached transmission data may be discarded to free up the cache space.

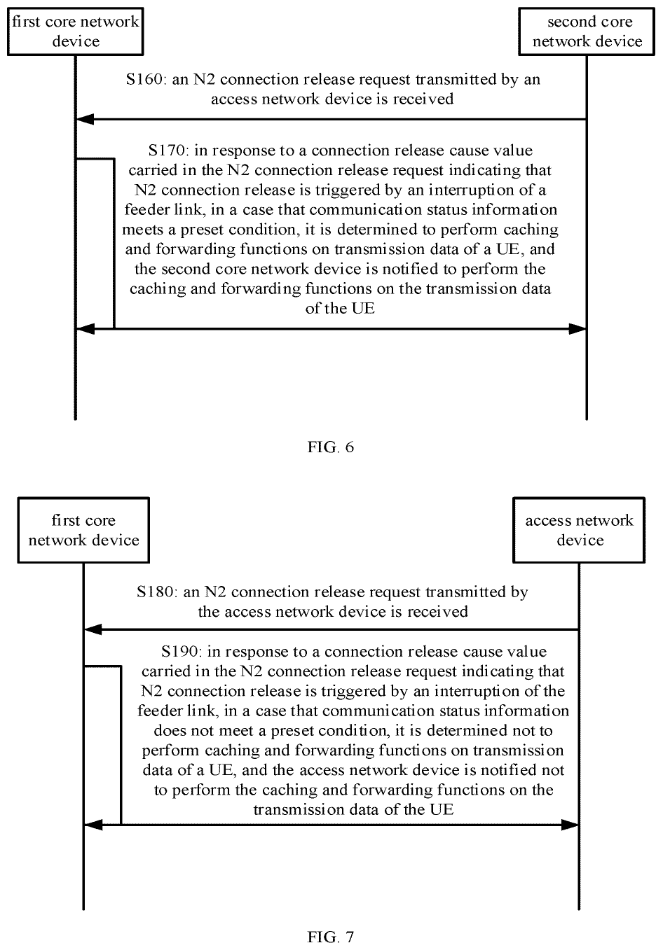

As shown in FIG. 6, an embodiment of the present disclosure provides a communication control method, which is performed by a first core network device. The method may include the following steps.

In step S160, an N2 connection release request transmitted by an access network device is received.

In step S170, in response to a connection release cause value carried in the N2 connection release request indicating that N2 connection release is triggered by an interruption of a feeder link, in a case that communication status information meets a preset condition, it is determined to perform caching and forwarding functions on transmission data of a UE, and a second core network device is notified to perform the caching and forwarding functions on the transmission data of the UE.

In the embodiments of the present disclosure, the notifying the second core network device to perform the caching and forwarding functions on the transmission data of the UE may include: notifying the second core network device to perform the caching and forwarding functions on downlink data of the UE based on timer information or an interruption duration of the feeder link.

In the embodiments of the present disclosure, the second core network device may be UPF or SMF, etc. The notifying the second core network device to perform the caching and forwarding functions on the downlink data of the UE based on the timer information or the interruption duration of the feeder link may include: transmitting an execution command carrying the timer information or the interruption duration of the feeder link to the second core network device, where the command is used to instruct the second core network device to perform the caching and forwarding functions on the downlink data of the UE based on the timer information or the interruption duration.

In an embodiment, the notifying the second core network device to perform the caching and forwarding functions on downlink data of the UE based on the timer information or the interruption duration may include: notifying the second core network device to cache the downlink data of the UE and starting a timing function based on the timer information or the interruption duration of the feeder link; and transmitting the downlink data of the UE cached, in response to resuming a connection between the access network device and the core network device after the timer duration corresponding to the timer information or the interruption duration expires.

For example, the second core network device is notified to start caching the downlink data of the UE when detecting the interruption of the feeder link, and to enable the timing function based on timer information or the interruption duration of the feeder link.

In an embodiment, the notifying the second core network device to perform the caching and forwarding functions on downlink data of the UE based on the timer information or the interruption duration may further include: notifying the second core network device to delete the downlink data of the UE cached, in response to not resuming the connection between the access network device and the core network device after the timer duration corresponding to the timer information or the interruption duration expires.

In this way, the second core network device and the first core network device can cache and forward the transmission data in cooperation, thereby improving the efficiency and the flexibility of data caching and forwarding, and further improving service continuity.

As shown in FIG. 7, an embodiment of the present disclosure provides a communication control method, which is performed by a first core network device. The method may include the following steps.

In step S180, an N2 connection release request transmitted by an access network device is received.

In step S190, in response to a connection release cause value carried in the N2 connection release request indicating that N2 connection release is triggered by an interruption of the feeder link, in a case that communication status information does not meet a preset condition, it is determined not to perform caching and forwarding functions on transmission data of a UE, and a second core network device is notified not to perform the caching and forwarding functions on the transmission data of the UE.

In the embodiments of the present disclosure, the case that the communication status information does not meet the preset condition may include that the caching and forwarding support capability information of the access network device indicates that the access network device does not support the caching and forwarding functions on the transmission data of the UE, and/or the caching and forwarding support capability information of the core network device indicates that the core network device does not support the caching and forwarding functions on the transmission data of the UE.

In an embodiment, the case that the communication status information does not meet the preset condition may also include that the user subscription information indicates that a type of a service subscribed by the UE is not a preset type. For example, the user subscription information indicates that the type of the service subscribed by the UE is not a high-latency type, etc.

In an embodiment, the case that the communication status information does not meet the preset condition may include that a timer duration corresponding to the timer information is larger than a preset threshold, and/or an interruption duration of the feeder link is larger than the preset threshold, etc. In this way, in the case that the interruption duration of the feeder link reaches the preset threshold, the data caching and forwarding functions are not enabled, which can reduce the amount of data cached during the interruption, thereby reducing resource occupation and waste caused by unnecessary data caching.

In an embodiment, the case that the communication status information does not meet the preset condition may include at least one of the three aforementioned embodiments, or may also include another type of communication status information not meeting the preset condition, which is not specifically limited here.

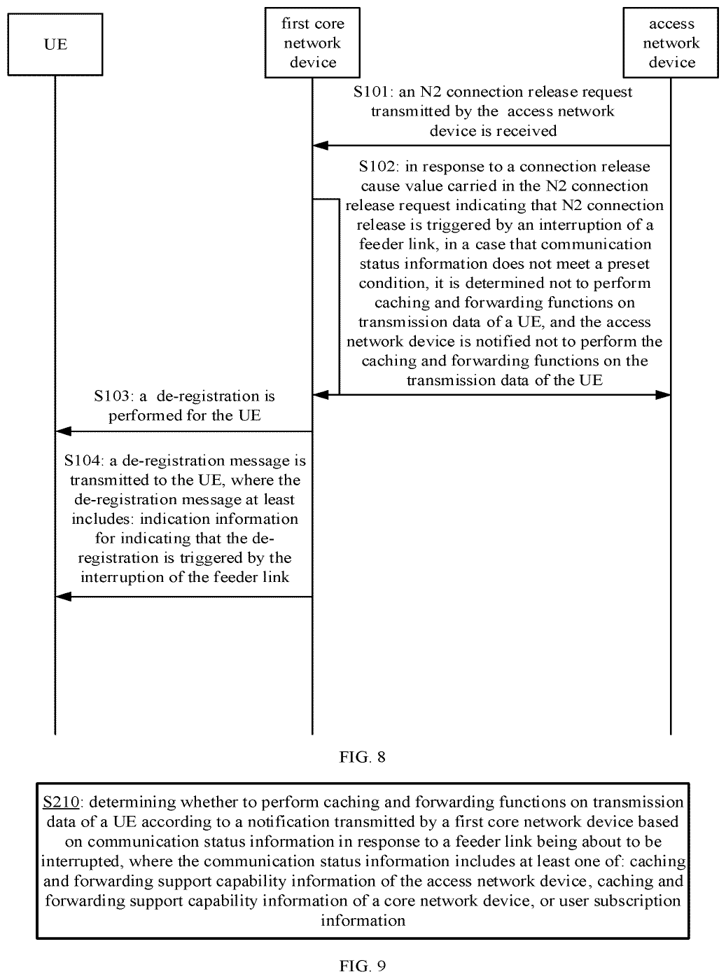

As shown in FIG. 8, an embodiment of the present disclosure provides a communication control method, which is performed by a first core network device. The method may include the following steps.

In step S101, an N2 connection release request transmitted by an access network device is received.

In step S102, in response to a connection release cause value carried in the N2 connection release request indicating that N2 connection release is triggered by an interruption of a feeder link, in a case that communication status information does not meet a preset condition, it is determined not to perform caching and forwarding functions on transmission data of a UE, and the access network device is notified not to perform the caching and forwarding functions on the transmission data of the UE.

In step S103, a de-registration is performed for the UE.

In step S104, a de-registration message is transmitted to the UE, where the de-registration message at least includes: indication information for indicating that the de-registration is triggered by the interruption of the feeder link.

In the embodiments of the present disclosure, the de-registration may include deleting registration information of the UE recorded in the first core network device AMF. For example, the de-registration process may be initiated by the AMF. After the de-registration is completed, the AMF may also transmit the de-registration message to the UE to notify the UE that the de-registration process has been completed, and the de-registration message may also indicate that the de-registration is triggered by the interruption of the feeder link.

In an embodiment, the indication information for indicating that the de-registration is triggered by the interruption of the feeder link may be a cause value indicating that a cause for triggering the de-registration is the interruption of the feeder link. For example, the cause value may be a cause identifier having a mapping relationship with the cause for triggering the de-registration. For example, the cause value may include one or more bit values, and different cause values correspond to different causes for triggering the de-registration

In an embodiment, in response to the connection release cause value carried in the N2 connection release request indicating that the N2 connection release is triggered by the interruption of the feeder link, in a case that communication status information does not meet the preset condition, the first core network device may further transmit an N2 connection release message to the access network device, so as to instruct the access network device to perform an N2 connection release operation. After receiving the N2 connection release operation, the access network device may perform a UE context release operation to release the N2 connection.

In an embodiment, the first core network device may further receive an N2 connection release completion message transmitted by the access network device after completing the N2 connection release.

In an embodiment, in a case that the communication status information does not meet the preset condition, the first core network device may also release a protocol data unit (PDU) session with a second core network device, such as UPF or SMF, and/or, may release an N4 connection between the second core network devices, e.g., between UPF and SMF.

As shown in FIG. 9, an embodiment of the present disclosure provides a communication control method, which is performed by an access network device. The method may include the following steps.

In step S210, whether to perform caching and forwarding functions on transmission data of a UE is determined according to a notification transmitted by a first core network device based on communication status information in response to a feeder link being about to be interrupted, where the communication status information includes at least one of: caching and forwarding support capability information of the access network device, caching and forwarding support capability information of a core network device, or user subscription information.

In an embodiment of the present disclosure, the notification transmitted by the first core network device based on the communication status information may be a notification transmitted by the first core network device when the communication status information meets the preset condition, or may also be a notification transmitted by the first core network device when the communication status information does not meet the preset condition.

For example, the notification received when the communication status information meets the preset condition may indicate to perform the caching and forwarding functions on the transmission data of the UE; the notification received when the communication status information does not meet the preset condition may indicate not to perform the caching and forwarding functions on the transmission data of the UE.

The access network device caching and forwarding the transmission data of the UE may include the access network device caching and forwarding uplink data of the UE.

In an embodiment, the case that the communication status information meets the preset condition may include that the caching and forwarding support capability information of the access network device indicates that the access network device supports the caching and forwarding functions on the transmission data of the UE, and the caching and forwarding support capability information of the core network device indicates that the core network device supports the caching and forwarding functions on the transmission data of the UE.

In an embodiment, the case that the communication status information meets the preset condition may also include that the user subscription information indicates that a type of a service subscribed by the UE is a preset type. For example, the user subscription information indicates that the type of the service subscribed by the UE is a high-latency type, etc.

In an embodiment, the case that the communication status information meets the preset condition may include that a timer duration corresponding to the timer information is less than a preset threshold, and/or an interruption duration of the feeder link is less than the preset threshold, etc. In this way, the interruption duration of the feeder link is less than the preset threshold, which can reduce the amount of data cached during the interruption, thereby reducing resource occupation and waste caused by unnecessary data caching.

In an embodiment, the case that the communication status information meets the preset condition may include at least one of the three aforementioned embodiments, or may also include another type of communication status information meeting the preset condition, which is not specifically limited here.

In an embodiment, the determining to perform the caching and forwarding functions on the transmission data of the UE may include: determining to perform the caching and forwarding functions on the downlink data of the UE. For example, it may include: the first core network device performing the caching and forwarding functions on the downlink data of the UE, and/or notifying a second core network device to perform caching and forwarding functions on the downlink data of the UE, etc. The notifying the access network device to perform the caching and forwarding functions on the transmission data of the UE may include: notifying the access network device to perform the caching and forwarding functions on the uplink data of the UE.

The downlink data may be data to be transmitted to the UE by the core network device such as AMF, UPF or SMF, where the data is, for example, service data transmitted by a service server or signaling initiated by the network side. The uplink data may be data to be reported to the access network device such as a base station, where the data is, for example, signaling or service data.

In some embodiments, the method may further include: transmitting an N2 connection release request to the first core network device in response to detecting that the feeder link is about to be interrupted, where the N2 connection release request indicates at least one of: a connection release cause value, caching and forwarding support capability information of the access network device, timer information, or feeder link information; the caching and forwarding support capability information of the access network device indicates whether the access network device supports the caching and forwarding functions; the feeder link information is used to determine at least one of: an establishment time instant, an establishment duration, an interruption time instant, and an interruption duration of the feeder link; and a timer duration corresponding to the timer information is greater than or equal to the interruption duration of the feeder link.

In an embodiment, after transmitting the N2 connection release request, in a case that the communication status information meets a preset condition, the access network device may further receive an N2 connection release message transmitted by the first core network device to instruct the access network device to perform an N2 connection release operation. After receiving the N2 connection release message, the access network device may perform a UE context release operation to release the N2 connection.

In an embodiment, after completing the N2 connection release operation, the access network device may transmit an N2 connection release completion message to the first core network device.

In some embodiments, the determining whether to perform the caching and forwarding functions on the transmission data of the UE according to the notification transmitted by the first core network device based on the communication status information includes: maintaining an RRC connection with the UE, in response to the notification transmitted by the first core network device based on the communication status information indicating to perform the caching and forwarding functions on the transmission data of the UE; caching uplink data of the UE, in response to detecting that a connection of the feeder link is interrupted; and transmitting the uplink data of the UE cached, in response to detecting that the connection of the feeder link is resumed and a connection between the access network device and the core network device is resumed.

In the embodiments of the present disclosure, since the access network device needs to perform the caching and forwarding functions on the transmission data of the UE, the RRC connection is maintained to persistently receive the uplink data of the UE for caching.

In an embodiment, when detecting that the connection of the feeder link is resumed, the access network device may also start resuming the connection between the access network device and the core network device, such as starting resuming the N2 connection and/or the N3 connection.

When detecting that the connection of the feeder link is resumed and the connection between the access network device and the core network device is resumed, that is, the connection of the feeder link, the N2 connection and the N3 connection are all resumed, the cached uplink data of the UE may be transmitted.

In some embodiments, the method may further include: deleting the uplink data of the UE cached, in response to detecting that the connection of the feeder link is resumed and the connection between the access network device and the core network device is not resumed.

In some embodiments, the method may further include: deleting the uplink data of the UE cached, in response to not resuming the connection between the access network device and the core network device after the timer duration corresponding to the timer information or the interruption duration of the feeder link expires.

In some embodiments, the determining whether to perform the caching and forwarding functions on the transmission data of the UE according to the notification transmitted by the first core network device based on the communication status information includes: releasing an RRC connection with the UE, in response to the notification transmitted by the first core network device based on the communication status information indicating not to perform the caching and forwarding functions on the transmission data of the UE.

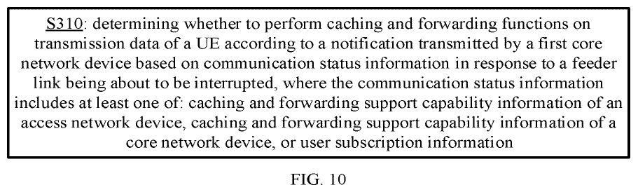

As shown in FIG. 10, an embodiment of the present disclosure provides a communication control method, which is performed by a second core network device. The method includes the following steps.

In step S310, whether to perform caching and forwarding functions on transmission data of a UE is determined according to a notification transmitted by a first core network device based on communication status information in response to a feeder link being about to be interrupted, where the communication status information includes at least one of: caching and forwarding support capability information of an access network device, caching and forwarding support capability information of a core network device, or user subscription information.

In the embodiments of the present disclosure, the notification transmitted by the first core network device based on the communication status information may be a notification transmitted by the first core network device when the communication status information meets the preset condition, or may also be a notification transmitted by the first core network device when the communication status information does not meet the preset condition.

For example, the notification received when the communication status information meets the preset condition may indicate to perform the caching and forwarding functions on the transmission data of the UE; the notification received when the communication status information does not meet the preset condition may indicate not to perform the caching and forwarding functions on the transmission data of the UE.

The access network device caching and forwarding the transmission data of the UE may include the access network device caching and forwarding the downlink data of the UE.

In an embodiment, the case that the communication status information meets the preset condition may include that the caching and forwarding support capability information of the access network device indicates that the access network device supports the caching and forwarding functions on the transmission data of the UE, and the caching and forwarding support capability information of the core network device indicates that the core network device supports the caching and forwarding functions on the transmission data of the UE.

In an embodiment, the case that the communication status information meets the preset condition may also include that the user subscription information indicates that a type of a service subscribed by the UE is a preset type. For example, the user subscription information indicates that the type of the service subscribed by the UE is a high-latency type, etc.

In an embodiment, the case that the communication status information meets the preset condition may include that a timer duration corresponding to the timer information is less than a preset threshold, and/or an interruption duration of the feeder link is less than the preset threshold, etc. In this way, the interruption duration of the feeder link is less than the preset threshold, which can reduce the amount of data cached during the interruption, thereby reducing resource occupation and waste caused by unnecessary data caching.

In an embodiment, the case that the communication status information meets the preset condition may include at least one of the three aforementioned embodiments, or may also include another type of communication status information meeting the preset condition, which is not specifically limited here.

In an embodiment, the determining to perform the caching and forwarding functions on the transmission data of the UE may include: determining to perform the caching and forwarding functions on the downlink data of the UE. For example, it may include: the first core network device performing the caching and forwarding functions on the downlink data of the UE, and/or notifying a second core network device to perform caching and forwarding functions on the downlink data of the UE, etc. The notifying the access network device to perform the caching and forwarding functions on the transmission data of the UE may include: notifying the access network device to perform the caching and forwarding functions on the uplink data of the UE.

The downlink data may be data to be transmitted to the UE by the core network device such as AMF, UPF or SMF, where the data is, for example, service data transmitted by a service server or signaling initiated by the network side. The uplink data may be data to be reported to the access network device such as a base station, where the data is, for example, signaling or service data.

In an embodiment, the determining whether to perform the caching and forwarding functions on the transmission data of the UE according to the notification transmitted by the first core network device based on the communication status information includes: determining timer information or an interruption duration of the feeder link according to the notification transmitted by the first core network device based on the communication status information; and performing the caching and forwarding functions on the transmission data of the UE based on the timer information or the interruption duration of the feeder link.

In an embodiment, the performing the caching and forwarding functions on the transmission data of the UE based on the timer information or the interruption duration of the feeder link includes: caching downlink data of the UE and starting a timing function based on the timer information or the interruption duration of the feeder link; and transmitting the downlink data of the UE cached, in response to resuming a connection between the access network device and the core network device after the timer duration corresponding to the timer information or the interruption duration expires.

In an embodiment, in response to detecting that the feeder link is disconnected, caching of the downlink data of the UE may be started, and the timing function based on the timer information or the interruption duration of the feeder link may be started. The first core network device AMF may be configured to cache the downlink data of the UE, or may be configured to cache the downlink data of the UE together with another core network device such as UPF and/or SMF.

In an embodiment, in a case that the connection between the access network device and the core network device is resumed after the timer duration corresponding to the timer information or the interruption duration expires from a cache starting time of the downlink data, downlink data cached from the cache starting time is transmitted.

In an embodiment, the resuming the connection between the access network device and the core network device may include resuming a connection of the feeder link, or may include resuming a connection of the feeder, and resuming an N2 connection and an N3 connection. The N2 connection is a connection link between the base station and the AMF, and the N3 connection is a connection link between the base station and the UPF.

In an embodiment, in a case that the feeder link is interrupted and the communication status information meets the preset condition, it is determined to perform the caching and forwarding functions on the transmission data of the UE, and at this time, the N2 connection and the N3 connection are disconnected. When the connection of the feeder link is resumed, the base station may indicate resuming the N2 connection and the N3 connection. In response to all the feeder link, the N2 connection and the N3 connection being resumed, normal communication and interaction can be resumed. In this case, transmission data cached during connection interruption is transmitted, which can ensure the sustainability of a UE service in a discontinuous connection state of the feeder link.

In an embodiment, when the first core network device determines not to perform the caching and forwarding functions on the transmission data of the UE, for example, the communication status information does not meet the preset condition, the first core network device may also release a protocol data unit (PDU) session between the first core network device and a second core network device, such as UPF or SMF, and/or, may release an N4 connection between the first core network device and the second core network device, such as UPF and SMF.

In some embodiments, the method further includes: deleting the downlink data of the UE cached, in response to not resuming the connection between the access network device and the core network device after the timer duration corresponding to the timer information or the interruption duration expires.

In the embodiments of the present disclosure, from the starting time of caching the transmission data of the UE, after the timer duration or the interruption duration has expired, if the connection between the access network device and the core network device is not resumed, such as the feeder link has not been resumed, or the N2 connection and/or the N3 connection has not been resumed after the feeder link is resumed, it may be considered that too much transmission data is cached. Therefore, deleting the cached downlink data of the UE can reduce the occupation by the data cache.

In an embodiment, the method may further include: instructing the access network device to delete the cached UE uplink data, in response to not resuming the connection between the access network device and the core network device after the timer duration corresponding to the timer information or the interruption duration expires. For example, after the timing based on the timer duration or the interruption duration is completed, if the connection between the access network device and the core network device has not been resumed, for example, the connection of the feeder link has not resumed, or the N2 connection and/or the N3 connection has still not been resumed after the feeder link has been resumed, a cache deletion command may be transmitted to the access network device to instruct the access network device to delete the cached uplink data of the UE.

In this way, if the link has not resumed to a connected state after the timing function has been performed for a certain period of time, it may be considered that the link interruption time and the data caching time are too long, and the cached transmission data may be discarded to free up the cache space.

An embodiment of the present disclosure provides a communication control system. The system includes: a first core network device, an access network device, and a second core network device.

The first core network device is configured to receive an N2 connection release request transmitted by the access network device, and determine whether to perform caching and forwarding functions on transmission data of a UE based on communication status information in response to a feeder link being about to be interrupted; where the communication status information includes at least one of: caching and forwarding support capability information of the access network device, caching and forwarding support capability information of a core network device, or user subscription information.

The access network device is configured to transmit the N2 connection release request to the first core network device, in response to detecting that the feeder link is about to be interrupted, and determine whether to perform the caching and forwarding functions on the transmission data of the UE based on a notification transmitted by the first core network device based on the communication status information.

The second core network device is configured to determine whether to perform the caching and forwarding functions on the transmission data of the UE according to the notification transmitted by the first core network device based on the communication status information.

An embodiment of the present disclosure provides a communication control method in a case of discontinuous connection of a feeder link of a satellite. Uplink and downlink data of a UE is cached when a connection of the feeder link is interrupted, and the cached uplink and downlink data of the UE is transmitted when the connection is resumed, so as to achieve the continuation of a high-latency service under the discontinuous connection, which is specifically as follow.
1. An access network device (gNB) detects that the connection of the feeder link is about to be interrupted, and sends an N2 connection release request to a first core network device (AMF) to release an access network (AN) connection, where a request message is used for indicating a cause for connection release.

The connection release request may also include at least one of: caching and forwarding support capability information of the gNB; timer information; or feeder link information.

The timer duration is set to be not less than an interruption duration of the feeder link, and a timer is used to notify a core network device to start caching downlink data for a UE. The feeder link information is used to determine an establishment time instant, an establishment duration, an interruption time instant, an interruption duration of the feeder link, etc.

In a case that the access network device does not support caching and forwarding, the access network device initiates release of an RRC connection of the UE and explains to the UE that the cause for the connection release is that the feeder link is interrupted.

In a case that the access network device supports caching and forwarding, the UE context and an RRC connection between the UE and the access network device are saved, and caching is started when the feeder link is interrupted. When the feeder link is re-established, establishment of N2 connection and N3 connection is initiated, and cached data is transmitted.
2. The core network device receives the connection release request and confirms the connection release and subsequent processing based on the cause for the connection release.

The subsequent processing includes: determining whether to enable data caching for the UE based on the caching and forwarding support capability information of the gNB, user subscription information, and caching and forwarding support capability information of the core network device. If the caching is not enabled, the core network device initiates a UE de-registration process and explains that a cause for de-registration is the interruption of the feeder link. If the caching is enabled, a registration status of the UE is maintained.

In a case that the timer information is received, the UE context is saved, a timer is started for timing and caching of the downlink data of the UE is started, and/or the second core network device is notified to start the timer for timing and to start caching the downlink data of the UE. When the timer expires, the downlink data is transmitted, or the downlink data is discarded.

In a case that the feeder link information is received, the establishment time instant, the establishment duration, the interruption time instant, the interruption duration of the feeder link and the like are determined based on the information, and caching of the downlink data of the UE is started based on the interruption duration, and/or the second core network device is notified to start caching the downlink data of the UE according to the interruption duration. When the interruption duration expires, downlink information is transmitted, or the downlink data is discarded.

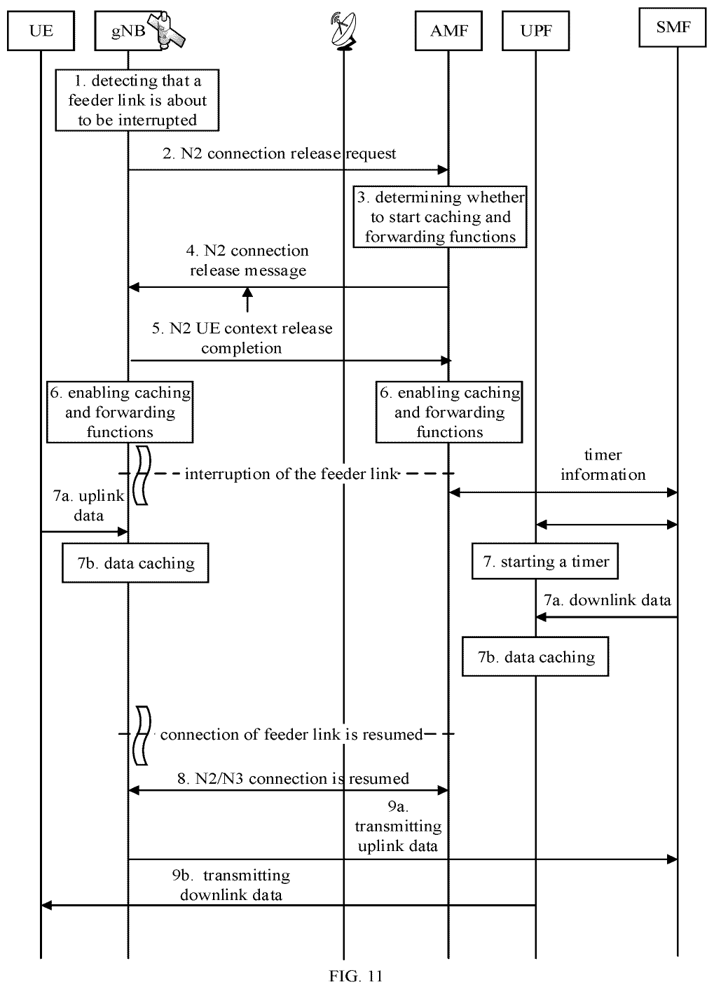

As shown in FIG. 11, the access network device and the core network device support data caching and forwarding functions. When the feeder link is interrupted, uplink and downlink data caching process is started for the UE as follows.
1. The gNB detects that a feeder link between a satellite and a ground station is about to be interrupted.
2. The gNB sends an N2 connection release request to the AMF, to request N2 connection release. A request message includes a cause value used to indicate that the connection release is caused by an interruption of the feeder link. Meanwhile, the request message may also include capability information whether the gNB supports data caching and forwarding functions (store & forward), and if supported, the request message may also include timer information. A timer duration corresponding to the timer information is set to be not less than an interruption duration of the feeder link.
3. The AMF receives the request and learns that an N2 connection is released due to the interruption of the feeder link. When the feeder link is interrupted, the AMF determines whether to start data caching and forwarding functions for the UE based on user subscription information (such as whether a service subscribed by the UE is a high-latency service) and whether the core network device (such as UPF or SMF) supports data caching and forwarding capabilities.
4. The AMF returns an N2 connection release message to the gNB, to notify the UE to start the data caching and forwarding functions.
5. The gNB returns an N2 connection release completion message, such as a UE context release completion message. Since the gNB activates the data caching and forwarding functions, the gNB maintains the RRC connection with the UE when the feeder link is interrupted.
6. When the feeder link is interrupted, the sides of gNB and AMF enable the data caching and forwarding functions. The AMF sends the timer information to the SMF or the UPF, to request the SMF or the UPF to activate the data caching and forwarding functions.
7. During an interruption process of the feeder link, the uplink data (such as signaling or service data) transmitted by the UE is cached on the side of the gNB. The downlink data of the UE (such as service data transmitted by a service server or signaling initiated by the network side) is cached on the side of the AMF, the SMF, or the UPF.
8. When the feeder link is resumed and re-established, the gNB initiates N2 and N3 connection establishment process, the gNB sends the cached uplink data, and the AMF, the SMF, or the UPF sends the cached downlink data. Alternatively, if the timer expires and the N2 and/or N3 connections are still not established, and the cached uplink and downlink data are discarded.

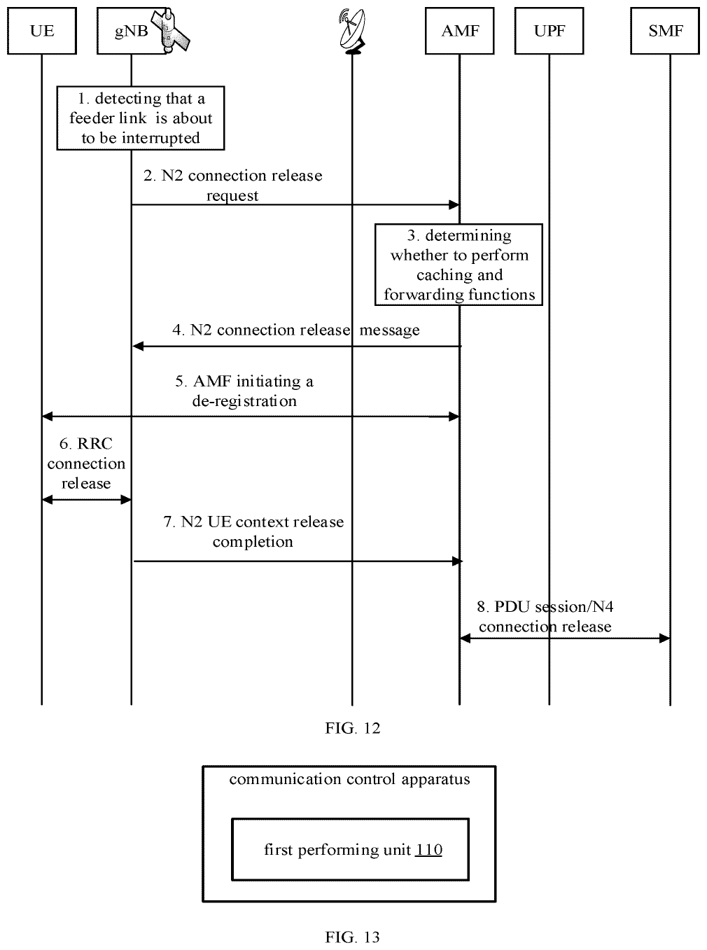

As shown in FIG. 12, the access network device and/or the core network device do not support data caching and forwarding functions. When the feeder link is interrupted, the network initiates a UE de-registration process as follows.
1. The gNB detects that a feeder link between a satellite and a ground station is about to be interrupted.
2. The gNB sends an N2 connection release request message to the AMF, to request N2 connection release. A request message includes a cause value used to indicate that the connection release is caused by an interruption of the feeder link. Meanwhile, the request message may also include capability information whether the gNB supports data caching and forwarding (store & forward) functions, and if supported, the request message may also include timer information. A timer duration corresponding to the timer information is set to be not less than an interruption duration of the feeder link.
3. The AMF receives the request and learns that an N2 connection is released due to the interruption of the feeder link. When the feeder link is interrupted, the AMF determines whether to perform data caching and forwarding functions for the UE based on user subscription information (such as whether a service subscribed by the UE is a high-latency service) and whether the core network device (such as UPF or SMF) supports data caching and forwarding capabilities. In a case that the UPF does not support data caching and forwarding, or determines that an interruption duration is too long based on the timer duration or an interruption duration of the feeder link, and there is a lot of cached data, seriously affecting the performance of the device, the UPF does not authorize to start the data caching and forwarding functions in this case.
4. The AMF returns an N2 connection release command message to the gNB, to notify that the data caching and forwarding functions are not to be started.
5. The AMF initiates a de-registration process for the UE and may notify that the de-registration is caused by the interruption of the feeder link.
6. After receiving the message, the gNB initiates an RRC connection release process.
7. The gNB returns an N2 connection release completion message.
8. The AMF completes a PDU session with the SMF and the UPF and a release process of the N4 connection.

As shown in FIG. 13, an embodiment of the present disclosure provides a communication control apparatus, which is applied to a first core network device. The apparatus may include: an first performing unit 110, configured to determine whether to perform caching and forwarding functions on transmission data of a user equipment (UE) based on communication status information in response to a feeder link being about to be interrupted, where the communication status information includes at least one of: caching and forwarding support capability information of an access network device, caching and forwarding support capability information of a core network device, or user subscription information.

In some embodiments, the first performing unit 110 is further configured to: receive an N2 connection release request transmitted by the access network device, where the feeder link being about to be interrupted includes: a connection release cause value carried in the N2 connection release request indicates that N2 connection release is triggered by an interruption of the feeder link.

In some embodiments, the N2 connection release request indicates at least one of: the connection release cause value, the caching and forwarding support capability information of the access network device, timer information, or feeder link information, the caching and forwarding support capability information of the access network device indicates whether the access network device supports the caching and forwarding functions, the feeder link information is used to determine at least one of: an establishment time instant, an establishment duration, an interruption time instant, or an interruption duration of the feeder link, and a timer duration corresponding to the timer information is greater than or equal to the interruption duration of the feeder link.

In some embodiments, the first performing unit 110 is configured to: in a case that the communication status information meets a preset condition, determine to perform the caching and forwarding functions on the transmission data of the UE, and notify the access network device to perform the caching and forwarding functions on the transmission data of the UE.

In some embodiments, the first performing unit 110 is configured to: cache downlink data of the UE and start a timing function based on the timer information or the interruption duration of the feeder link; and transmit the downlink data of the UE cached, in response to resuming a connection between the access network device and the core network device after the timer duration corresponding to the timer information or the interruption duration expires.

In some embodiments, the first performing unit 110 is further configured to: delete the downlink data of the UE cached, in response to not resuming the connection between the access network device and the core network device after the timer duration corresponding to the timer information or the interruption duration expires.

In some embodiments, the first performing unit 110 is further configured to: notify a second core network device to perform the caching and forwarding functions on the downlink data of the UE based on the timer information or the interruption duration of the feeder link.

In some embodiments, the first performing unit 110 is configured to: in a case that the communication status information does not meet a preset condition, determine not to perform the caching and forwarding functions on the transmission data of the UE, and notify the access network device not to perform the caching and forwarding functions on the transmission data of the UE.

In some embodiments, the first performing unit 110 is further configured to: perform de-registration for the UE; and transmit a de-registration message to the UE, where the de-registration message at least includes: indication information for indicating that the de-registration is triggered by the interruption of the feeder link.

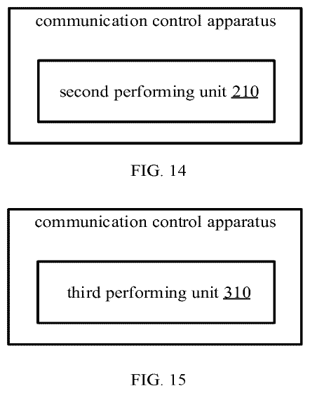

As shown in FIG. 14, an embodiment of the present disclosure provides a communication control apparatus, which is applied to an access network device. The apparatus may include: a second performing unit 210, configured to: determine whether to perform caching and forwarding functions on transmission data of a UE according to a notification transmitted by a first core network device based on communication status information in response to a feeder link being about to be interrupted, where the communication status information includes at least one of: caching and forwarding support capability information of the access network device, caching and forwarding support capability information of a core network device, or user subscription information.

In some embodiments, the second performing unit 210 is further configured to: transmit an N2 connection release request to the first core network device in response to detecting that the feeder link is about to be interrupted, where the N2 connection release request indicates at least one of: a connection release cause value, caching and forwarding support capability information of the access network device, timer information, or feeder link information; the caching and forwarding support capability information of the access network device indicates whether the access network device supports the caching and forwarding functions; the feeder link information is used to determine at least one of: an establishment time instant, an establishment duration, an interruption time instant, and an interruption duration of the feeder link; and a timer duration corresponding to the timer information is greater than or equal to the interruption duration of the feeder link.

In some embodiments, the second performing unit 210 is configured to: maintain a radio resource control (RRC) connection with the UE, in response to the notification transmitted by the first core network device based on the communication status information indicating to perform the caching and forwarding functions on the transmission data of the UE; cache uplink data of the UE, in response to detecting that a connection of the feeder link is interrupted; and transmit the uplink data of the UE cached, in response to detecting that the connection of the feeder link is resumed and a connection between the access network device and the core network device is resumed.

In some embodiments, the second performing unit 210 is further configured to: delete the uplink data of the UE cached, in response to detecting that the connection of the feeder link is resumed and the connection between the access network device and the core network device is not resumed.

In some embodiments, the second performing unit 210 is configured to: release an RRC connection with the UE, in response to the notification transmitted by the first core network device based on the communication status information indicating not to perform the caching and forwarding functions on the transmission data of the UE.

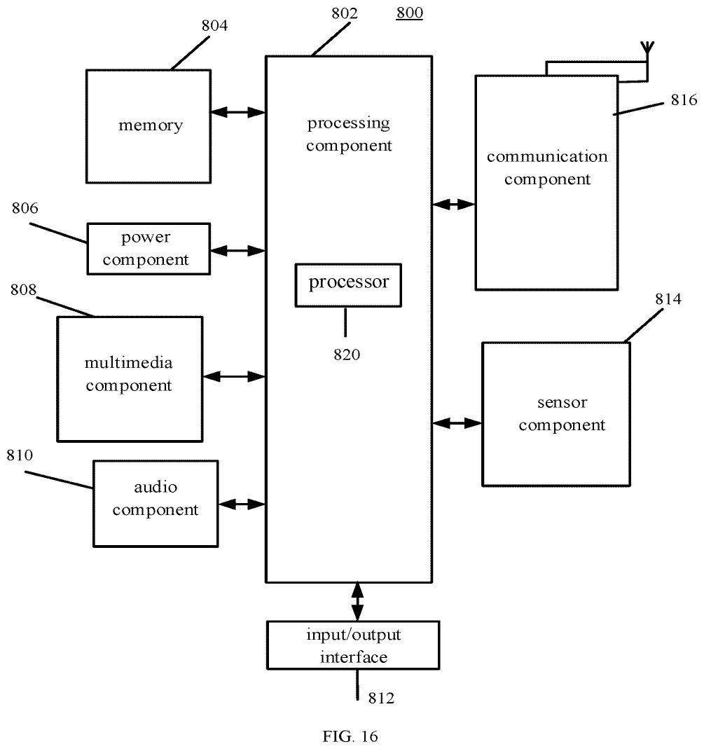

As shown in FIG. 15, an embodiment of the present disclosure provides a communication control apparatus, which is applied to a second core network device. The apparatus includes: a third performing unit 310, configured to: determine whether to perform caching and forwarding functions on transmission data of a UE according to a notification transmitted by a first core network device based on communication status information in response to a feeder link being about to be interrupted, where the communication status information includes at least one of: caching and forwarding support capability information of an access network device, caching and forwarding support capability information of a core network device, or user subscription information.

In some embodiments, the third performing unit 310 is configured to: determine timer information or an interruption duration of the feeder link according to the notification transmitted by the first core network device based on the communication status information; and perform the caching and forwarding functions on the transmission data of the UE based on the timer information or the interruption duration of the feeder link.

In some embodiments, the third performing unit 310 is configured to: cache downlink data of the UE and start a timing function based on the timer information or the interruption duration of the feeder link; and transmit the downlink data of the UE cached, in response to resuming a connection between the access network device and the core network device after the timer duration corresponding to the timer information or the interruption duration expires.

In some embodiments, the third performing unit 310 is further configured to: delete the downlink data of the UE cached, in response to not resuming the connection between the access network device and the core network device after the timer duration corresponding to the timer information or the interruption duration expires.

An embodiment of the present disclosure provides a communication device, including: a memory configured to store instructions executable by a processor; and a processor connected to the memory, where the processor is configured to execute the communication control method provided by any of the foregoing technical solutions.

The processor may include various types of storage media, and the storage media are non-transitory computer storage media that may continue to store information stored thereon after the communication device is powered off.

Here, the communication device includes: a terminal or a network element, and the network element may be any one of the aforementioned first to fourth network elements.

The processor may be connected to the memory through a bus or the like, and may be configured to read an executable program stored in the memory, for example, at least one of the methods shown in FIG. 2, and FIG. 5 to FIG. 12.

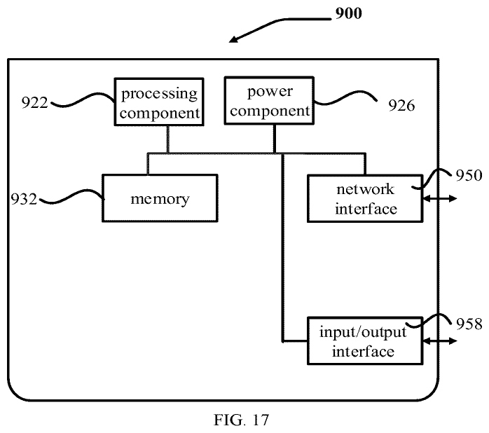

FIG. 16 is a block diagram of a UE 800 according to an illustrative embodiment. For example, the UE 800 may be a mobile phone, a computer, a digital broadcast user device, a message transceiver device, a game console, a tablet device, a medical device, a fitness device, a personal digital assistant, or the like.

Referring to FIG. 16, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the UE 800, such as the operations associated with display, phone calls, data communications, camera operations, and recording operations. The processing component 802 may include one or more processors 820 to execute instructions to perform all or some of the steps in the above-described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the UE 800. Examples of such data include instructions for any applications or methods operated on the UE 800, contact data, phonebook data, messages, pictures, videos, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 806 provides power to various components of the UE 800. The power component 806 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 808 includes a front camera and/or a rear camera. The front camera and/or the rear camera may receive an external multimedia datum while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as keyboards, click wheels, buttons, and the like. The buttons may include, but are not limited to, a home button, a volume button, a starting button, and a locking button.

The sensor component 814 includes one or more sensors to provide status assessments of various aspects of the UE 800. For instance, the sensor component 814 may detect an open/closed status of the UE 800, relative positioning of components, e.g., the display and the keypad, of the UE 800, a change in position of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of nearby objects without any physical contact. The sensor component 814 may further include a light sensor, such as a CMOS or CCD image sensor, for use in imaging applications. In some embodiments, the sensor component 814 may further include an accelerometer sensor, a gyroscope sensor, a magnetic sensor, a pressure sensor, or a temperature sensor.

The communication component 816 is configured to facilitate communication, wired or wireless, between the UE 800 and other devices. The UE 800 may access a wireless network based on a communication standard, such as Wi-Fi, 4G, or 5G, or a combination thereof. In an illustrative embodiment, the communication component 816 receives a broadcast signal or broadcast associated information from an external broadcast management system via a broadcast channel. In an illustrative embodiment, the communication component 816 further includes a near field communication (NFC) module to facilitate short-range communications. For example, the NFC module may be implemented based on a radio frequency identifier (RFID) technology, an infrared data association (IrDA) technology, an ultra-wideband (UWB) technology, a Bluetooth (BT) technology, and other technologies.

In an illustrative embodiment, the UE 800 may be implemented with one or more of an application specific integrated circuits (ASIC), a digital signal processor (DSP), a digital signal processing device (DSPD), a programmable logic device (PLD), a field programmable gate array (FPGA), a controller, a micro-controller, a microprocessor, or other electronic elements, for performing the above-mentioned method.

In an illustrative embodiment, there is also provided a non-transitory computer-readable storage medium including instructions, such as included in the memory 804, executable by the processor 820 in the UE 800, for completing the above-mentioned method. For example, the non-transitory computer-readable storage medium may be a ROM, a random access memory (RAM), a CD-ROM, a magnetic tape, a floppy disc, an optical data storage device, and the like.

As shown in FIG. 17, an embodiment of the present disclosure provides a structure of a communication device 900. For example, the communication device 900 may be provided as a network-side device. The communication device 900 may be the above base station or gNB.

Referring to FIG. 17, the base station 900 includes a processing component 922, which further includes one or more processors, and memory resources represented by a memory 932 for storing instructions executable by the processing component 922, such as an application program. The application program stored in the memory 932 may include one or more modules each corresponding to a set of instructions. In addition, the processing component 922 is configured to execute instructions to perform any method applied to the base station as described above, for example, at least one of the methods as shown in FIG. 2, and FIG. 5 to FIG. 12.

The base station 900 may further include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™, or the like.

Other embodiments of the present invention will be apparent to those skilled in the art from consideration of the specification and practice of the present disclosure disclosed here. The present disclosure is intended to cover any variations, uses, or adaptations of the present invention following the general principles thereof and including such departures from the present invention as come within known or customary practice in the art. It is intended that the specification and examples be considered as illustrative only, with a true scope and spirit of the present invention being indicated by the scope of the following claims.

It will be appreciated that the present invention is not limited to the exact construction that has been described above and illustrated in the accompanying drawings, and that various modifications and changes can be made without departing from the scope thereof. It is intended that the scope of the present invention is only limited by the scope of the appended claims.

1. A communication control method, performed by a first core network device, comprising:
determining whether to perform caching and forwarding functions on transmission data of a user equipment (UE) based on communication status information in response to a feeder link being about to be interrupted, wherein the communication status information comprises at least one of: caching and forwarding support capability information of an access network device, caching and forwarding support capability information of a core network device, or user subscription information.

2. The method according to claim 1, further comprising:
receiving an N2 connection release request transmitted by the access network device,
wherein the feeder link being about to be interrupted comprises:
a connection release cause value carried in the N2 connection release request indicates that N2 connection release is triggered by an interruption of the feeder link.

3. The method according to claim 2, wherein the N2 connection release request indicates at least one of: the connection release cause value, the caching and forwarding support capability information of the access network device, timer information, or feeder link information,
the caching and forwarding support capability information of the access network device indicates whether the access network device supports the caching and forwarding functions,
the feeder link information is used to determine at least one of: an establishment time instant, an establishment duration, an interruption time instant, or an interruption duration of the feeder link, and
a timer duration corresponding to the timer information is greater than or equal to the interruption duration of the feeder link.

4. The method according to claim 3, wherein the determining whether to perform the caching and forwarding functions on the transmission data of the UE based on the communication status information comprises:
in a case that the communication status information meets a preset condition, determining to perform the caching and forwarding functions on the transmission data of the UE, and notifying the access network device to perform the caching and forwarding functions on the transmission data of the UE.

5. The method according to claim 4, wherein the determining to perform the caching and forwarding functions on the transmission data of the UE comprises:
caching downlink data of the UE and starting a timing function based on the timer information or the interruption duration of the feeder link; and
transmitting the downlink data of the UE cached, in response to resuming a connection between the access network device and the core network device after the timer duration corresponding to the timer information or the interruption duration expires.

6. The method according to claim 5, further comprising:
deleting the downlink data of the UE cached, in response to not resuming the connection between the access network device and the core network device after the timer duration corresponding to the timer information or the interruption duration expires.

7. The method according to claim 4, further comprising:
notifying a second core network device to perform the caching and forwarding functions on the downlink data of the UE based on the timer information or the interruption duration of the feeder link.

8. The method according to claim 3, wherein the determining whether to perform the caching and forwarding functions on the transmission data of the UE based on the communication status information comprises:
in a case that the communication status information does not meet a preset condition, determining not to perform the caching and forwarding functions on the transmission data of the UE, and notifying the access network device not to perform the caching and forwarding functions on the transmission data of the UE.

9. The method according to claim 8, further comprising:
performing de-registration for the UE; and
transmitting a de-registration message to the UE, wherein the de-registration message at least comprises: indication information for indicating that the de-registration is triggered by the interruption of the feeder link.

10. A communication control method, performed by an access network device, comprising:
determining whether to perform caching and forwarding functions on transmission data of a UE according to a notification transmitted by a first core network device based on communication status information in response to a feeder link being about to be interrupted, wherein the communication status information comprises at least one of: caching and forwarding support capability information of the access network device, caching and forwarding support capability information of a core network device, or user subscription information.

11. The method according to claim 10, further comprising:
transmitting an N2 connection release request to the first core network device in response to detecting that the feeder link is about to be interrupted,
wherein the N2 connection release request indicates at least one of: a connection release cause value, caching and forwarding support capability information of the access network device, timer information, and feeder link information;
the caching and forwarding support capability information of the access network device indicates whether the access network device supports the caching and forwarding functions;
the feeder link information is used to determine at least one of: an establishment time instant, an establishment duration, an interruption time instant, and an interruption duration of the feeder link; and
a timer duration corresponding to the timer information is greater than or equal to the interruption duration of the feeder link.

12. The method according to claim 11, wherein the determining whether to perform the caching and forwarding functions on the transmission data of the UE according to the notification transmitted by the first core network device based on the communication status information comprises:
maintaining a radio resource control (RRC) connection with the UE, in response to the notification transmitted by the first core network device based on the communication status information indicating to perform the caching and forwarding functions on the transmission data of the UE;
caching uplink data of the UE, in response to detecting that a connection of the feeder link is interrupted; and
transmitting the uplink data of the UE cached, in response to detecting that the connection of the feeder link is resumed and a connection between the access network device and the core network device is resumed.

13. The method according to claim 12, further comprising:
deleting the uplink data of the UE cached, in response to detecting that the connection of the feeder link is resumed and the connection between the access network device and the core network device is not resumed.

14. The method according to claim 10, wherein the determining whether to perform the caching and forwarding functions on the transmission data of the UE according to the notification transmitted by the first core network device based on the communication status information comprises:
releasing an RRC connection with the UE, in response to the notification transmitted by the first core network device based on the communication status information indicating not to perform the caching and forwarding functions on the transmission data of the UE.

15-22. (canceled)

23. A communication device, comprising a processor, a memory, and an executable program stored on the memory and executable by the processor, wherein when running the executable program, the processor is configured to perform following operations:
determining whether to perform caching and forwarding functions on transmission data of a user equipment (UE) based on communication status information in response to a feeder link being about to be interrupted, wherein the communication status information comprises at least one of: caching and forwarding support capability information of an access network device, caching and forwarding support capability information of a core network device, or user subscription information.

24. A non-transitory computer-readable storage medium, configured to store an executable program that, when executed by a processor, implements the method according to claim 1.

26. A communication device, comprising a processor, a memory, and an executable program stored on the memory and executable by the processor, wherein when running the executable program, the processor is configured to perform the method according to claim 10.

27. A non-transitory computer-readable storage medium, configured to store an executable program that, when executed by a processor, implements the method according to claim 10.

28. The communication device according to claim 23, wherein the processor is further configured to:
receive an N2 connection release request transmitted by the access network device,
wherein the feeder link being about to be interrupted comprises:
a connection release cause value carried in the N2 connection release request indicates that N2 connection release is triggered by an interruption of the feeder link.

29. The communication device according to claim 28, wherein the N2 connection release request indicates at least one of: the connection release cause value, the caching and forwarding support capability information of the access network device, timer information, or feeder link information,
the caching and forwarding support capability information of the access network device indicates whether the access network device supports the caching and forwarding functions,
the feeder link information is used to determine at least one of: an establishment time instant, an establishment duration, an interruption time instant, or an interruption duration of the feeder link, and
a timer duration corresponding to the timer information is greater than or equal to the interruption duration of the feeder link.
